(19) United States
(12) Patent Application Publication
(10) Pub. No.: US 2008/0315698 A1
(43) Pub. Date: Dec. 25, 2008

(54) MOTOR APPARATUS AND METHOD

(76) Inventors: Ayman M. El-Refaie, Niskayuna, NY (US); Michael Ciccarelli, West Sand Lake, NY (US); Ronghai Qu, Clifton Park, NY (US); Lembit Salasoo, Schenectady, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 12/199,851

(22) Filed: Aug. 28, 2008

Related U.S. Application Data
(63) Continuation-in-part of application No. 11/559,505, filed on Nov. 14, 2006.
Application No. 11/559,505 is a continuation-in-part of application No. 10/882,911, filed on Jun. 30, 2004, now Pat. No. 7,154,191.
Application No. 10/882,911 is a continuation-in-part of application No. 11/559,506, filed on Nov. 14, 2006.
Application No. 11/559,506 is a continuation-in-part of application No. 10/951,329, filed on Sep. 27, 2004, now Pat. No. 7,154,192.
Application No. 10/951,329 is a continuation-in-part of application No. 10/951,335, filed on Sep. 27, 2004, now Pat. No. 7,154,193.
Application No. 10/951,335 is a continuation-in-part of application No. 11/639,892, filed on Dec. 15, 2006.

(51) Int. Cl. H02K 17/18; H02K 7/116

(52) U.S. Cl. 310/124; 310/83

(57) ABSTRACT

An apparatus includes a first motor and a second motor. The first motor includes a first rotor configured to provide mechanical power to a vehicle, and a first plurality of stator coils having a core and coupled to the first rotor. The second motor includes a second rotor configured to provide mechanical power to the vehicle, and a second plurality of stator coils sharing the same core as the first plurality of stator coils and coupled to the second rotor.

### CROSS REFERENCE TO RELATED APPLICATIONS

The present application is a continuation-in-part of and claims priority of U.S. patent application Ser. No. 11/559,505 filed Nov. 14, 2006, which claims priority of U.S. patent application Ser. No. 10/882,911 filed Jun. 30, 2004 and issued as U.S. Pat. No. 7,154,191 on Dec. 26, 2006, the disclosure of which is incorporated herein. The present application is a continuation-in-part of and claims priority to U.S. patent application Ser. No. 11/559,506 filed Nov. 14, 2006, which claims priority of U.S. patent application Ser. No. 10/951,329 filed Sep. 27, 2004 and issued as U.S. Pat. No. 7,154,192 on Dec. 26, 2006, and which also claims priority of U.S. patent application Ser. No. 10/951,335 filed Sep. 27, 2004 and issued as U.S. Pat. No. 7,154,193 on Dec. 26, 2006, the disclosures of which are incorporated herein. The present application is a continuation-in-part of and claims priority to U.S. patent application Ser. No. 11/639,892 filed Dec. 15, 2006, the disclosure of which is incorporated herein.

### BACKGROUND

1. Technical Field

The invention includes embodiments that relate to a motor apparatus, and to a method of using a double-sided motor.

2. Discussion of Art

In a drive system, an induction traction motor can drive one axle of a vehicle. The vehicle can have multiple axles and induction motors to drive the axles. In a design having six induction motors and six axles, each induction motor drives one axle each.

An induction motor tends to be heavy. Such weight may increase the overall vehicle weight, thereby increasing traction effort by increasing friction between a wheel and a track. The weight of the induction motor may be decreased, to an extent, by decreasing its size. The size of a motor decreases as the operational speed increases. While a properly matched induction motor/axle pair may result in the induction motor being coupled to the axle in 1:1 directly-coupled relationship, reduction in induction motor weight may require connection to the axle through a gearbox to gear down the motor speed to that of the axle to enable peak operation of the induction motor. Thus, although some benefit (weight decrease and increase in power density) may be obtained by decreasing the size of the motor, such benefits may be offset by inclusion of a gearbox due to the mismatch of speeds between the motor and the axle. Furthermore, decreasing the size of the motor may cause the motor to have inadequate power to drive a vehicle.

Vehicle efficiency may also be improved by, for instance, the use of hybrid technologies. Hybrid technologies may combine an internal combustion engine and an electric motor, have been considered in locomotives in order to reduce energy consumption and, therefore, cost of operation. However, hybrid systems may require a relatively large bank of batteries for energy storage. And although there may be a net improvement in energy efficiency with their use, the battery bank tends to add considerable weight to the overall system. Despite any improvement in traction that may be experienced with such a heavier system, such additional weight may exceed the desired locomotive weight. As a result, the locomotive load may need to be reduced in order to keep the overall load unchanged. For example, in some countries, such as China, there is a weight limit due to different track size and conditions. Thus, in order to operate in such countries, the weight of the locomotive must be reduced to meet requirements within those markets.

Therefore, there is a need to reduce locomotive weight while maintaining needed power output capability. As such, it would be desirable to design an apparatus and method to enable the use of reduced weight motors while not compromising overall power output capabilities. It may be desirable to have a system that has aspects and features that differ from those systems that are currently available. It may be desirable to have a method that differs from those methods that are currently available.

### BRIEF DESCRIPTION OF THE INVENTION

According to one aspect of the invention, an apparatus includes a first motor and a second motor. The first motor includes a first rotor configured to provide mechanical power to a vehicle, and a first plurality of stator coils having a core and coupled to the first rotor. The second motor includes a second rotor configured to provide mechanical power to the vehicle, and a second plurality of stator coils sharing the same core as the first plurality of stator coils and coupled to the second rotor.

In accordance with another aspect of the invention, a method includes coupling a first plurality of stator coils to a first rotor, coupling a second plurality of stator coils to a second rotor, attaching the first plurality of stator coils to the second plurality of stator coils through a common core, and coupling the first and second rotors to a vehicular powertrain via at least one gearbox.

Yet another aspect of the invention includes, an apparatus includes a first axle, a second axle, and a powertrain for a vehicle. The powertrain includes a first stator bank coupled to a first rotor, and a second stator bank coupled to a second rotor. Each of the first and second rotors is coupled to one of the first axle and second axle of the vehicle, and the first and second stator banks are attached to each other through a common core.

Various other features will be made apparent from the following detailed description and the drawings.

### BRIEF DESCRIPTION OF THE DRAWINGS

The drawings illustrate embodiments of the invention.

In the drawings:

FIG. 1 is a cross-sectional view of a double-sided radial flux Permanent Magnet (PM) motor.

FIG. 2 is a perspective view of a double-sided axial flux PM motor.

FIG. 3 is a plan view of one embodiment of a locomotive drive train having a double-sided axial flux PM motor.

FIG. 4 is a plan view of one embodiment of a locomotive drive train having a double-sided radial flux PM motor.

FIG. 5 is a plan view of one embodiment of a locomotive drive train having a double-sided radial flux PM motor.

FIG. 6 is a plan view of one embodiment of a locomotive drive train having a double-sided axial flux PM motor.

### DETAILED DESCRIPTION

The invention includes embodiments that relate to an apparatus for providing mechanical power to a vehicle. The invention also includes embodiments that relate to a method of fabricating a vehicular powertrain to a vehicle. The invention includes embodiments that relate to locomotives, automobiles, off-highway vehicles, and underground vehicles.

According to one embodiment of the invention, an apparatus includes a first motor and a second motor. The first motor includes a first rotor configured to provide mechanical power to a vehicle, and a first plurality of stator coils having a core and coupled to the first rotor. The second motor includes a second rotor configured to provide mechanical power to the vehicle, and a second plurality of stator coils sharing the same core as the first plurality of stator coils and coupled to the second rotor.

In accordance with another embodiment of the invention, a method includes coupling a first plurality of stator coils to a first rotor, coupling a second plurality of stator coils to a second rotor, attaching the first plurality of stator coils to the second plurality of stator coils through a common core, and coupling the first and second rotors to a vehicular powertrain via at least one gearbox.

In accordance with another embodiment of the invention, an apparatus includes a first axle, a second axle, and a powertrain for a vehicle. The powertrain includes a first stator bank coupled to a first rotor, and a second stator bank coupled to a second rotor. Each of the first and second rotors is coupled to one of the first axle and second axle of the vehicle, and the first and second stator banks are attached to each other through a common core.

The invention includes embodiments that employ double-sided Permanent Magnet (PM) traction motors having both axial and radial flux configurations. In embodiments described, double-sided motors power a locomotive, however the embodiments described may be equally applicable to powertrains used to drive other types of vehicles, such as automobiles, off-highway vehicles (OHV), underground vehicles, and the like.

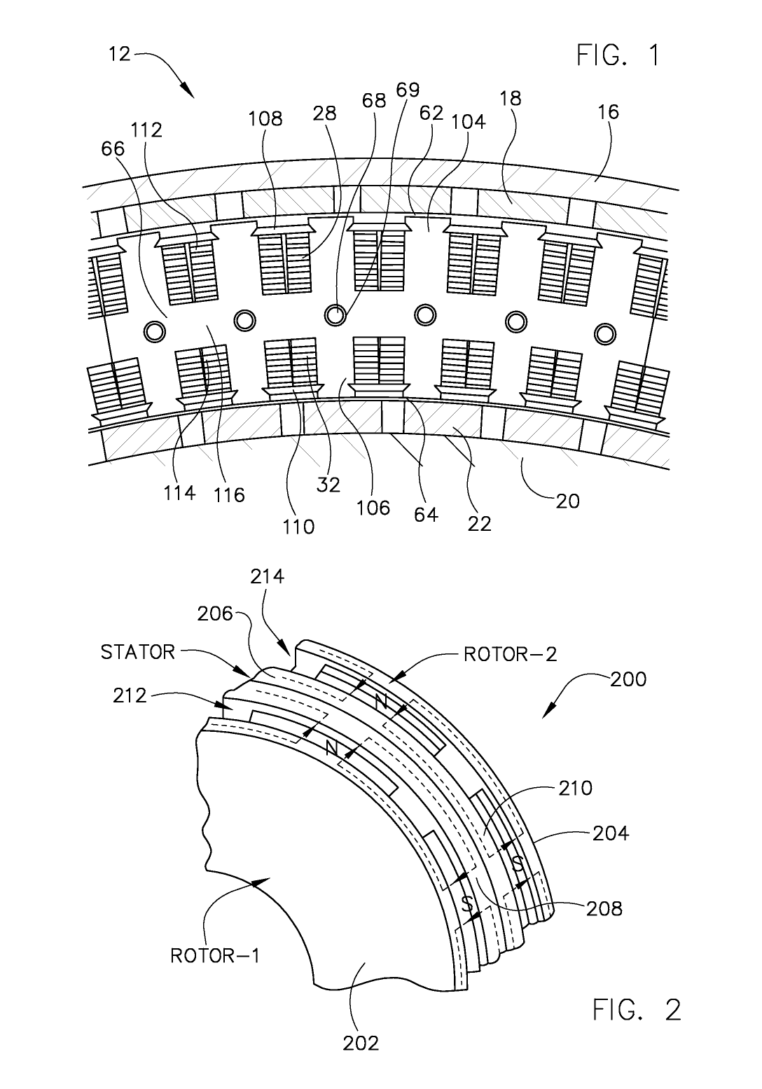

Referring to FIG. 1, a cross-sectional view of a double-sided radial flux PM motor 12 includes outer rotor core 16 with outer permanent magnets 18 and an inner rotor core 20 with inner permanent magnets 22. The outer and inner stator tooth (teeth) are denoted generally by reference numerals 104 and 106 respectively and the outer stator winding (coils) 28 and the inner stator winding (coils) 32 are retained respectively by the outer stator coil retaining wedge 108 and inner stator coil retaining wedge 110. The double-sided stator as described herein above contributes the outer air gap 62 and inner air gap 64. The structural integrity of the stator is achieved through compression of the lamination stack 66; via numerous axial bolts 68 located in the stator yoke 116. The bolt bodies (not shown) and at least one end are insulated from the laminations and frame structures to avoid induced electrical currents and resulting losses and heating. In one example, at least one bolt per slot is used; e.g., with boltholes 69 as illustrated in FIG. 1. The bolthole positions may vary. In a specific example, the bolthole positions may be aligned with stator teeth 104, 106. Also illustrated are cooling air passages as described herein above, the cooling air passage 112 between outer stator windings and the cooling air passage 114 between the inner stator windings.

In a radial flux configuration, the double-sided PM motor 12 illustrated includes inner stator windings 32 that are coupled, or attached (through a common core), to the outer stator winding coils 28, and that drive respective rotors 20, 16. The coupling can be direct (with no intervening parts), or can be indirect (and include intervening parts) based on the end use. In operation, inner stator windings 32 are caused to impart mechanical power to the inner rotor 20, and outer stator windings 28 are caused to impart mechanical power to the outer rotor 16. A control system (not shown) as well as sensors, communication apparatus, and actuators are provided as needed.

Referring to FIG. 2, a perspective view of a double-sided axial flux PM motor 200 includes a first rotor 202 and a second rotor 204. Motor 200 includes a double-sided stator 206 having first and second stators 208, 210, which impart mechanical power to the first and second rotors 202, 204. Mechanical power is imparted to the first rotor 202 via the first stator 208, and mechanical power is imparted to the second rotor 204 via the second stator 210. The stators 208, 210 as described herein above contribute a first air gap 212 and a second air gap 214. Stator 206 may include, as illustrated, two stators 208, 210 that are mechanically coupled, or attached, to one another. However, the double-sided stator 206 may instead include a single stator having circuits coupled to respective rotors 202, 204.

Thus, in an axial flux configuration, the double-sided PM motor 200 illustrated includes first stator 208 that is coupled, or attached, to the second stator (through a common core) circuit 210, and drives respective rotors 202, 204. In operation, the first stator 208 is caused to impart mechanical power to the first rotor 202, and the second stator 210 is caused to impart mechanical power to the second rotor 204.

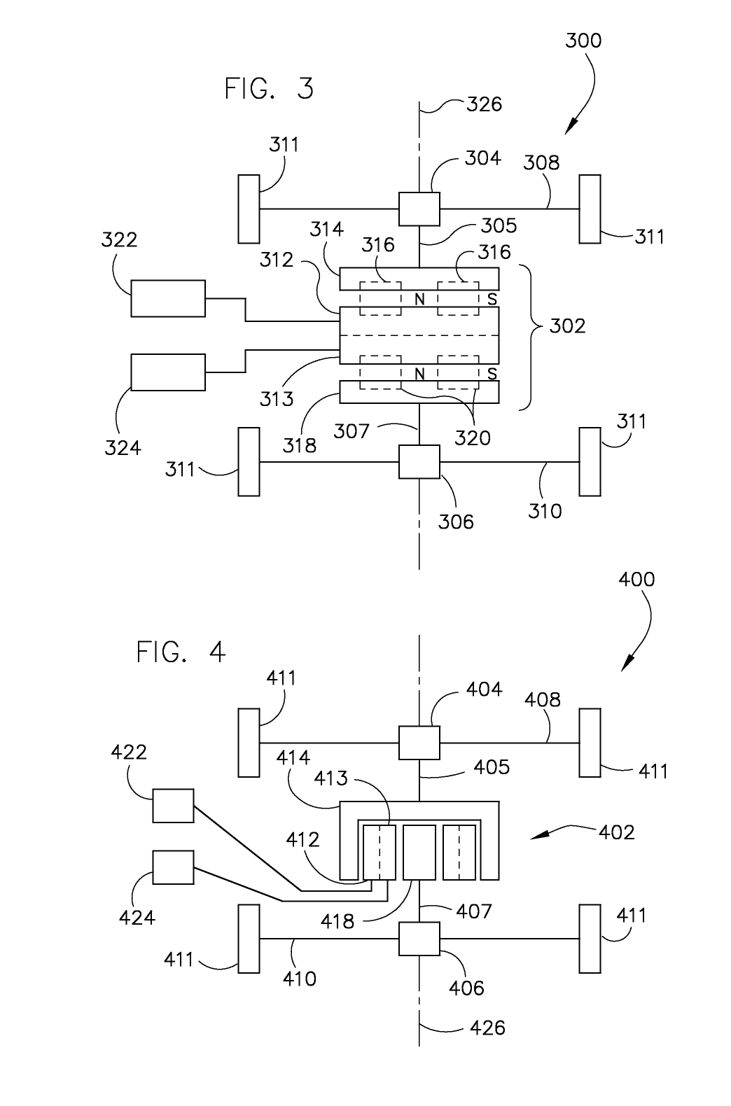

The double-sided radial flux PM motor 12 illustrated in FIG. 1 and the double-sided axial flux PM motor 200 illustrated in FIG. 2 may be used to power a vehicle, such as a locomotive, according to embodiments of the invention. Thus, FIGS. 3-6 illustrate axial flux and radial flux PM motors, in combination with respective gear boxes, that provide power to one or more axles of a locomotive.

Referring now to FIG. 3, a plan view of one embodiment of a locomotive drive train having a double-sided axial flux PM motor is shown. A locomotive 300 is powered using a double-sided axial flux PM motor 302 via a pair of differential gear boxes 304, 306 and via axles 308, 310. In this embodiment, the axial flux PM motor 302 includes a first stator 312 that is coupled to a first rotor 314 via first stator circuits 316 and a second stator 313 that is coupled to a second rotor 318 via second stator circuits 320. Rotors 314, 318 are coupled to gear boxes 304, 306, respectively, via respective power shafts 305, 307. In this embodiment, a first power converter 322 provides power to the first stator 312, and a second power converter 324 provides power to the second stator 313. Axles 308, 310 are coupled to wheels 311 of locomotive 300.

In operation, as power is imparted to each of the rotors 314, 318, rotors 314, 318 are caused to rotate about axis of rotor rotation 326, thus imparting power to wheels 311 via respective differential gear boxes 304, 306 and via respective power shafts 305, 307.

Referring now to FIG. 4, a plan view of one embodiment of a locomotive drive train having a double-sided radial flux PM motor is shown. A locomotive 400 is powered using a double-sided radial flux PM motor 402 via a pair of differential gear boxes 404, 406, and via axles 408, 410. An outer rotor 414 and an inner rotor 418 are coupled to gear boxes 404, 406, respectively, via respective power shafts 405, 407. In this embodiment, the radial flux PM motor 402 includes an outer stator 412 that is coupled to outer rotor 414 and an inner stator 413 that is coupled to an inner rotor 418. In this embodiment, a first power converter 422 provides power to the outer stator 412, and a second power converter 424 provides power to the inner stator 413. Axles 408, 410 are coupled to wheels 411 of locomotive 400.

In operation, as power is imparted to each of the rotors 414, 418, the rotors 414, 418 are caused to rotate about axis of rotor rotation 426, thus imparting power to wheels 411 via respective differential gear boxes 404, 406 and via respective power shafts 405, 407.

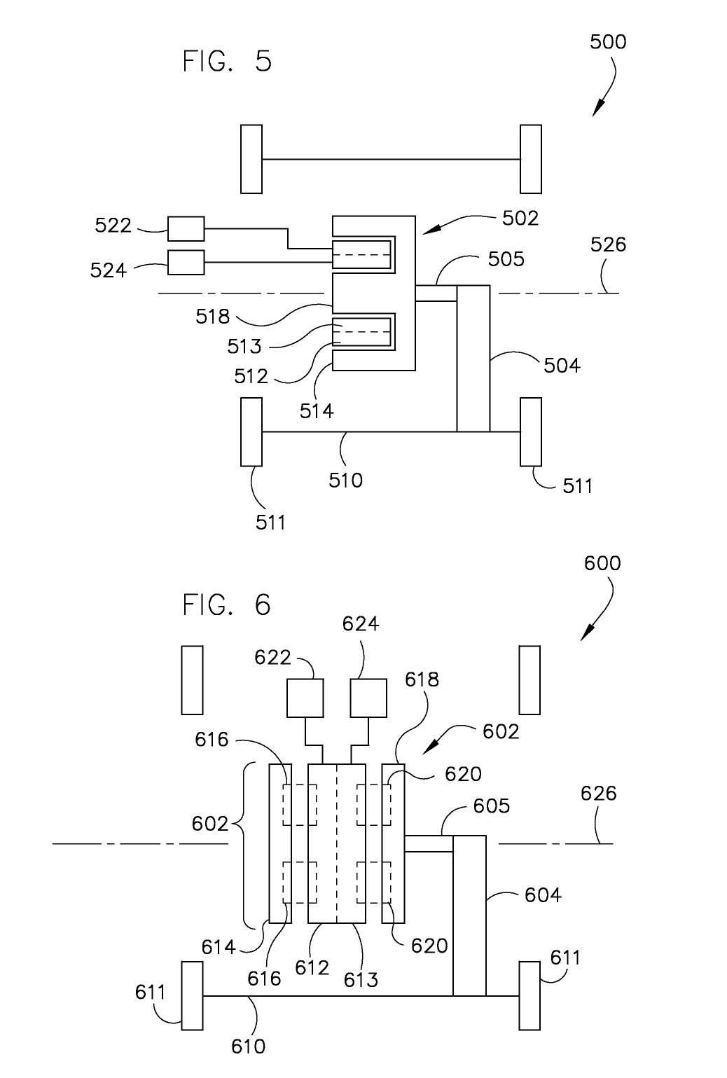

Referring now to FIG. 5, a plan view of one embodiment of a locomotive drive train having a double-sided radial flux PM motor is shown. A locomotive 500 is powered using a double-sided radial flux PM motor 502 via a gear box 504 and via axle 510. An outer rotor 514 and an inner rotor 518 are coupled together via a power shaft 505, which is coupled to gear box 504. In the illustrated embodiment, gear box 504 is configured as a linear gear box. In this embodiment, the radial flux PM motor 502 includes an outer stator 512 that is coupled to outer rotor 514 and an inner stator 513 that is coupled to an inner rotor 518. In this embodiment, a first power converter 522 provides power to the outer stator 512, and a second power converter 524 provides power to the inner stator 513. Axle 510 is coupled to wheels 511 of locomotive 500.

In operation, as power is imparted to power shaft 505 via each of the rotors 514, 518, rotors 514, 518 are caused to rotate about axis of rotor rotation 526, thus imparting power to wheels 511 via gear box 504.

Referring now to FIG. 6, a plan view of one embodiment of a locomotive drive train having a double-sided axial flux PM motor is shown. A locomotive 600 is powered using a double-sided axial flux PM motor 602 via a gear box 604 and via axle 310. In the illustrated embodiment, gear box 604 is configured as a linear gear box. Rotors 614, 618 are coupled to gear box 604 via power shaft 605. In this embodiment, the axial flux PM motor 602 includes a first stator 612 that is coupled to a first rotor 614 via first stator circuits 616 and a second stator 613 that is coupled to a second rotor 618 via second stator circuits 620. In this embodiment, a first power converter 622 provides power to the first stator 612, and a second power converter 624 provides power to the second stator 613. Axle 610 is coupled to wheels 611 of locomotive 600.

In operation, as power is imparted to each of the rotors 614, 618, rotors 614, 618 are caused to rotate about axis of rotor rotation 626, thus imparting power to wheels 611 via gear box 604 and via power shaft 605.

The invention has been described in terms of the preferred embodiment, and it is recognized that equivalents, alternatives, and modifications, aside from those expressly stated, are possible and within the scope of the appending claims.

What is claimed is:

1. An apparatus, comprising:
a first motor comprising:
a first rotor configured to provide mechanical power to a vehicle; and
a first plurality of stator coils having a core and coupled to the first rotor; and
a second motor comprising:
a second rotor configured to provide mechanical power to the vehicle; and
a second plurality of stator coils sharing the same core as the first plurality of stator coils and coupled to the second rotor.

2. The apparatus of claim 1, wherein the vehicle is one of a locomotive, an automobile, an off-highway vehicle (OHV), and an underground vehicle.

3. The apparatus of claim 1, wherein the apparatus is a locomotive drivetrain.

4. The apparatus of claim 1, wherein the first and second motors are configured in an axial flux configuration.

5. The apparatus of claim 4, further comprising:
a first axle;
a first differential gearbox;
a second axle; and
a second differential gearbox;
wherein the first rotor is coupled to the first axle via the first differential gearbox; and
wherein the second rotor is coupled to the second axle via the second differential gearbox.

6. The apparatus of claim 4, further comprising:
a first axle;
a gearbox; and
wherein the first and second rotors are each coupled to the first axle via the gearbox.

7. The apparatus of claim 1, wherein the first motor and the second motor are configured in a radial flux configuration.

8. The apparatus of claim 7, further comprising:
a first axle;
a first differential gearbox;
a second axle;
a second differential gearbox;
wherein the first rotor is coupled to the first axle via the first differential gearbox; and
wherein the second rotor is coupled to the second axle via the second differential gearbox.

9. The apparatus of claim 7, comprising:
a first axle;
a gearbox; and
wherein the first and second rotors are each coupled to the first axle via the gearbox.

10. A method, comprising:
coupling a first plurality of stator coils to a first rotor;
coupling a second plurality of stator coils to a second rotor;
attaching the first plurality of stator coils to the second plurality of stator coils through a common core; and
coupling the first and second rotors to a vehicular powertrain via at least one gearbox.

11. The method of claim 10, wherein the vehicular powertrain is a powertrain for one of a locomotive, an automobile, an off-highway vehicle (OHV), and an underground vehicle.

12. The method of claim 10, wherein attaching the first plurality of stator coils to the second plurality of stator coils comprises attaching the first and second pluralities of stators in an axial flux configuration.

13. The method of claim 12, comprising:
coupling the first rotor to the powertrain via a first differential gearbox; and
coupling the second rotor to the powertrain via a second differential gearbox.

14. The method of claim 12, comprising:
coupling the first and second rotors to a common drive shaft; and
coupling the common drive shaft to the powertrain via a gearbox.

15. The method of claim 10, wherein attaching the first plurality of stator coils to the second plurality of stator coils comprises attaching the first and second pluralities of stators in a radial flux configuration.

16. The method of claim 15, comprising:
coupling the first rotor to the powertrain via a first differential gearbox, and
coupling the second rotor to the powertrain via a second differential gearbox.

17. The method of claim 15, comprising:
coupling the first and second rotors to a common drive shaft; and
coupling the common drive shaft to the powertrain via a gearbox.

18. An apparatus, comprising:
a first axle;
a second axle; and
a powertrain for a vehicle, the powertrain comprising:
a first stator bank coupled to a first rotor; and
a second stator bank coupled to a second rotor;
wherein each of the first and second rotors is coupled to one of the first axle and second axle of the vehicle; and
wherein the first and second stator banks are attached to each other through a common core.

19. The apparatus of claim 18, wherein the vehicle comprises one of a locomotive, an automobile, an off-highway vehicle (OHV), and an underground vehicle.

20. The apparatus of claim 18, wherein the first and second rotors and first and second stator banks are configured in an axial flux configuration.

21. The apparatus of claim 20, further comprising:
a first differential gearbox; and
a second differential gearbox;
wherein the first rotor is coupled to the first axle via the first differential gearbox, and wherein the second rotor is coupled to the second axle via the second differential gearbox.

22. The apparatus of claim 20, further comprising:
a drive shaft; and
a gearbox;
wherein the first and second rotors are coupled to the drive shaft; and
wherein the drive shaft is coupled to one of the first and second axles via the gearbox.

23. The apparatus of claim 18, wherein the first and second rotors are configured in a radial flux configuration.

24. The apparatus of claim 23, further comprising:
a first axle;
a first differential gearbox;
a second axle; and
a second differential gearbox;
wherein the first rotor is coupled to the first axle via the first differential gearbox; and
wherein the second rotor is coupled to the second axle via the second differential gearbox.

25. The apparatus of claim 23, further comprising:
a drive shaft; and
a gearbox;
wherein the first and second rotors are coupled to the drive shaft; and
wherein the drive shaft is coupled to one of the first and second axles via the gearbox.
